(19) United States
(12) Patent Application Publication
(10) Pub. No.: US 2026/0356670 A1
(43) Pub. Date: Nov. 12, 2026

(54) PROCESS FOR PRODUCING AMMONIUM THIOSULPHATE

(71) Applicant: LIMITED LIABILITY COMPANY "GSM CHEMICAL", Moscow (RU)

(72) Inventors: Mikhail Vladimirovich GENKIN, Nizhny Novgorod (RU); Sergey Nikolaevich IGUMNOV, Moscow (RU)

(21) Appl. No.: 19/125,448

(22) PCT Filed: Oct. 16, 2023
(86) PCT No.: PCT/RU2023/050244

§ 371 Date: Apr. 29, 2025

(30) Foreign Application Priority Data
Nov. 7, 2022 (RU) 2022128751

(51) Int. Cl. C01B 17/64

(52) U.S. Cl. CPC C01B 17/64; C01P 2006/80

(57) ABSTRACT

A process for producing ammonium thiosulphate by reacting ammonia, sulphur dioxide and elemental sulphur in a reactor having a stirring device and a heating and cooling system includes: a) comminuting elemental sulphur to a particle size of less than 500 microns and feeding the comminuted sulphur into the reactor, b) feeding stoichiometric amounts of ammonia and sulphur dioxide into the reactor while keeping the contents of the reactor at a temperature of not more than 70 °C, c) introducing an additional amount of ammonia and keeping the contents of the reactor at a temperature in a range of 90-120 °C, d) filtering the resulting solution of ammonium thiosulphate, wherein the particle size of the elemental sulphur is less than 100 microns. The process makes it possible to: increase the speed of the reaction for the formation of ammonium thiosulphate from ammonia, sulphur dioxide and elemental sulphur; reduce the overall time of the reaction for the production of ammonium thiosulphate; and increase the quantitative yield and the purity of the resulting product.

### CROSS-REFERENCE TO RELATED APPLICATIONS

This application is a national phase application under 35 U.S.C. 371 of International Application No. PCT/RU2023/050244 filed Oct. 16, 2023, which claims the benefit of and priority to Russian Federation patent application No. 2022128751 filed Nov. 7, 2022, the contents of all of which being incorporated by reference in their entirety herein.

### TECHNICAL FIELD

The present disclosure relates to processes for producing ammonium thiosulphate and, more specifically, to processes for producing ammonium thiosulphate from ammonia and sulphur dioxide with the addition of elemental sulphur.

### BACKGROUND

U.S. Pat. No. 3,473,891 A discloses a two-step process for producing ammonium thiosulphate, wherein the first step comprises reacting an aqueous solution of ammonium bisulphite containing 32% SO₂ with an equimolar amount of gaseous ammonia and sulphur at atmospheric pressure and a temperature of 20-50 °C in a reactor having a stirrer for 2-3 hours. The second step comprises filtering the resulting solution through a packed tubular reactor filled with sulphur for complete conversion of ammonium sulphite. The residence time in the filter is 0.5 hours. Then the final decoloration of a 60% ammonium thiosulphate solution is carried out by adding ammonium bisulphite in an amount of 1% by weight of the initial mixture. The first step uses the solution pH of 8.8-9.2, hydrogen sulphide in an amount of 0.1 wt. % as a catalyst, and polyethylene glycol ether in an amount of 0.05 wt. % as a sulphur wetting agent.

U.S. Pat. No. 3,524,724 A discloses a two-step process for producing ammonium thiosulphate by reacting ammonia with sulphur dioxide and ammonium bisulphite in a concentrated ammonia solution with a concentration of 80% or more at a temperature of 60 °C and a pressure of 30 bar. Sulphur is dissolved in ammonia solution, and the precipitated ammonium thiosulphate product is discharged in solid form. A solution of sulphur and water in ammonia is removed from the first reactor to the second reactor for saturation with sulphur dioxide to produce ammonium bisulphite at a pressure of 30 bar and a temperature of 20 °C and is returned to the first reactor. The sulphur content in the solution is controlled, and its feeding to the reactor is also regulated. Ammonium sulphate and sulphite are produced as impurities in an amount of 3-10%, whereas the thiosulphate content is 85%. Sulphur dioxide is produced by burning sulphur in oxygen.

U.S. Pat. No. 4,478,807 A discloses a process for producing ammonium thiosulphate from sulphur dioxide, wherein ammonium sulphite is formed as an intermediate product in a reaction of purifying ammonia with sulphur dioxide in the presence of water. Preferably, ammonia is added to the sulphur dioxide at the bottom of the second wash reactor to keep sulphur dioxide and ammonia in a liquid phase.

US Patent Publication No. 2005/002852 A1 discloses a process for producing ammonium thiosulphate from a flue gas stream containing sulphur dioxide, comprising the following steps:
(a) contacting the flue gas stream with a plurality of streams of an aqueous ammonia solution;
(b) generating a scrubber product stream containing ammonium bisulphite and ammonium sulphite;
(c) passing the scrubber product stream through a fluidized bed reactor containing solid sulphur; and
(d) contacting the reactor feed stream with ammonia; and
(e) reacting the scrubber feed stream, sulphur and ammonia to form a thiosulphate product stream.

WO Patent Publication No. 03002455 A1 discloses a process for producing ammonium thiosulphate by oxidizing reduced sulphur compounds without forming elemental sulphur and without converting more than 9% of the sulphur compounds into sulphate ion. The process comprises oxidizing a thiosulphate solution with an oxidizing agent to produce a partially oxidized solution, adjusting the pH of the partially oxidized stream to a value from 5 to 8, and reacting the partially oxidized solution with a stream containing reduced sulphur compounds such that the reduced compounds are oxidized and the partially oxidized stream is reduced.

RO U.S. Pat. No. 118,279 B1 discloses a process for producing ammonium thiosulphate by synthesis from ammonium hydroxide, sulphur dioxide and elemental sulphur. The synthesis is carried out in one step by bubbling sulphur dioxide in a suspension containing a solution of ammonium thiosulphate having a concentration of 50 to 60%, a solution of ammonium hydroxide having a concentration of 25%, and elemental sulphur. The reaction mixture is heated to 75-85 °C. Sulphur dioxide and ammonium hydroxide are fed until the sulphur is completely dissolved. The resulting ammonium thiosulphate solution is filtered and crystallized.

The disadvantages of the known processes comprise a low process rate for producing ammonium thiosulphate, need of removing a large amount of heat generated when dissolving ammonia gas, and complex design of the line for producing ammonium thiosulphate due to the need of two steps in the process of producing ammonium thiosulphate.

GB Patent Publication No. 1175069 A discloses a continuous process for producing ammonium thiosulphate from ammonia, sulphur dioxide, water and elemental sulphur in an aqueous reaction medium containing ammonium thiosulphate, and discloses feeding ammonia and sulphur dioxide to said reaction medium in the first reactor to form ammonium sulphite, contacting a reaction medium containing ammonium sulphite in a first reactor with elemental sulphur in an amount significantly exceeding that stoichiometrically required to form ammonium thiosulphate, recirculating most of the reaction medium through the first reactor, withdrawing a portion of the reaction medium from said first reactor, and sending the withdrawn portion to a second reactor, wherein it is again contacted with excess sulphur to convert substantially all of still existing ammonium sulphite to ammonium thiosulphate, and recovering the ammonium thiosulphate from said second reactor.

The disadvantages of this known process comprise a low process rate for producing ammonium thiosulphate, low yield of the target ammonium thiosulphate product, complex design of the unit for producing ammonium thiosulphate due to the need of two reactors to produce ammonium thiosulphate in two steps.

### BRIEF SUMMARY

The technical objective of the present disclosure is to develop an effective and fast process for producing ammonium thiosulphate with high yield and purity of the resulting ammonium thiosulphate product.

The technical effects achieved by implementing various embodiments of the present disclosure comprise a higher reaction rate for producing ammonium thiosulphate from ammonia, sulphur dioxide and elemental sulphur, shorter reaction time for producing ammonium thiosulphate, higher yield and purity of the resulting product.

To achieve the above-mentioned technical effects, a process was developed for producing ammonium thiosulphate comprising interaction of ammonia and sulphur dioxide in a reactor equipped with a mixing device and a heating and cooling system, comprising:
a) comminuting elemental sulphur and feeding the comminuted sulphur into the reactor with water,
b) feeding ammonia and sulphur dioxide into the reactor while keeping the contents of the reactor at a temperature of not more than 70 °C,
c) introducing an additional amount of ammonia while keeping the contents of the reactor at a temperature in a range of 90-120 °C,
d) filtering the resulting solution of ammonium thiosulphate, wherein the elemental sulphur particle size is less than 100 microns.

Elemental sulphur is fed into the reactor as an aqueous suspension. In this case, the aqueous sulphur suspension contains at least 75 wt. % sulphur particles having a size less than 90 microns.

An aqueous sulphur suspension is prepared by dispersing molten sulphur sprayed through a pneumatic nozzle (5) into water.

Dispersion occurs by spraying liquid hot sulphur with a pneumatic nozzle and further phase transition of sulphur from a liquid to a solid state upon contact with water. To this end, the initial lump sulphur is melted, filtered from mechanical impurities, and fed for spraying. When sprayed through a pneumatic nozzle (5), liquid sulphur is dispersed into small droplets, which contact water and crystallize into a solid phase with a predominant particle size of less than 500 microns, preferably less than 100 microns, more specifically less than 90 microns. The minimum particle size is 2 microns.

The particle size of elemental sulphur is regulated by varying the feeding rate of the molten sulphur to the pneumatic nozzle (5) and the air feeding rate.

The particle size is further controlled with a hydrocyclone (3). The sulphur suspension is fed for classification into a hydrocyclone (3). The fine fraction (below 100 microns) from the upper outlet of the hydrocyclone is fed to the reactor (6) for the synthesis of ammonium thiosulphate, and the suspension of the coarse fraction (over 100 microns) from the lower outlet of the hydrocyclone is fed by gravity to wet grinding in a ball mill (4).

The temperature in the reactor (6) is maintained using water or steam by a heat exchanger or a jacket (7).

The ammonia feeding rate does not exceed 25-50 g/min, and the sulphur dioxide feeding rate does not exceed 50-100 g/min

The process is carried out continuously.

The degree of conversion of sulphur dioxide into ammonium thiosulphate reaches 96-98%, the content of ammonium thiosulphate as the major product in the solution is in the range of 57-61 wt. %, and the ammonium sulphite content does not exceed 1 wt. %. Thus, the product meets the standard requirements for use in photography (DIN 19 080 T82, ISO 3619), as well as in agrochemistry and metallurgy.

This summary is provided to introduce a selection of concepts in a simplified form that are further described below in the detailed description, and is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 shows a process flow diagram for producing ammonium thiosulphate.

FIG. 2 shows a unit for producing an aqueous suspension of elemental sulphur.

FIG. 3 shows the size distribution curves of sulphur particles produced by dispersing sulphur.

### DETAILED DESCRIPTION

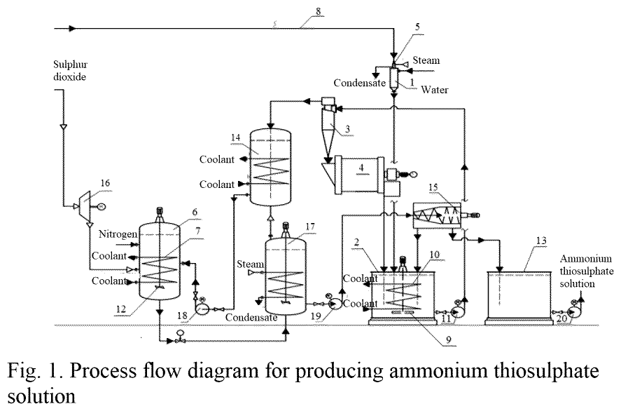

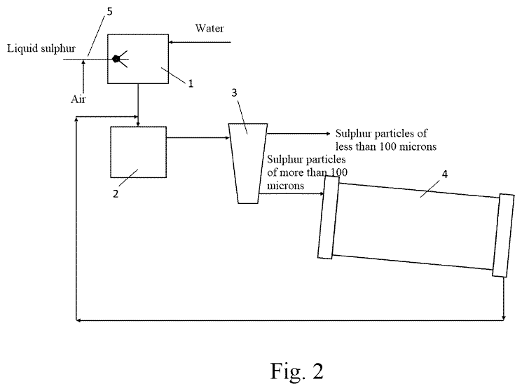

To produce ammonium thiosulphate, an aqueous suspension of elemental sulphur is produced in a unit for producing the suspension (FIGS. 1 and 2).

To produce an aqueous suspension of elemental sulphur, the initial lump sulphur is melted, filtered from mechanical impurities and fed to a pneumatic nozzle (5) for spraying. Filtered liquid sulphur enters the feeding line (8) of the contact crystallizer (1), and the above-mentioned liquid sulphur is injected through a steam-heated nozzle (5) into a stream of cold water also fed to the contact crystallizer (1) from the network pipeline. When mixed with water, liquid sulphur disperses and crystallizes as a solid phase with a predominant particle size of less than 100 microns, preferably the aqueous suspension of elemental sulphur contains at least 75 wt. % sulphur particles with particle size of less than 90 microns.

Further, a suspension of crystalline sulphur in water from the crystallizer (1) is fed into a tank (2) for a suspension of elemental sulphur, equipped with a stirrer (9) and a submersible heat exchanger (10). The heat released as a result of crystallization of liquid sulphur upon contact with water is absorbed in the tank (2) for a suspension of elemental sulphur by cooling the suspension with a submersible heat exchanger (10).

The suspension of sulphur is fed from the tank (2) by a pump (11) into a hydrocyclone (3) to classify the particles of elemental sulphur by size. A suspension of fine sulphur fraction (below 100 microns) from the upper outlet of the hydrocyclone (3) is fed to the reactor (6) for the synthesis of ammonium thiosulphate. Before entering the reactor (6), the elemental sulphur suspension enters the ammonia absorber (14). Since the suspension of elemental sulphur contains water, which can dissolve ammonia, to keep the material balance of the ammonium thiosulphate process, the aqueous suspension of elemental sulphur is used as a medium to absorb excess ammonia circulating in the system. The use of an ammonia absorber (14) allows increasing the rate of producing of ammonium thiosulphate and reducing the overall reaction time for production of ammonium thiosulphate.

A suspension of a coarse fraction of sulphur (over 100 microns) from the lower outlet of the hydrocyclone (3) flows by gravity for wet grinding into a ball mill (4), from where the ground product is fed by gravity to a tank (2) for the suspension of elemental sulphur.

The inner surface of the ball mill (4) drum is lined with Silex to avoid contamination of the comminuted mass with metal. The grinding bodies are flint balls with a diameter of 30-90 mm, high-alumina (uralite), cylindrical zirconia bodies.

The resulting aqueous suspension fed into the reactor (6) comprises finely ground elemental sulphur with a particle size of less than 100 microns, preferably less than 90 microns with an excess in the range from 50 to 100 wt. %.

The reaction is carried out by stirring the reaction mixture with a stirrer (12).

Stoichiometric amounts of ammonia and sulphur dioxide are fed into the reactor (6).

Ammonia and sulphur dioxide are fed into the reactor (6) simultaneously and continuously. Sulphur dioxide is fed as a wet gas, and ammonia is fed as liquid ammonia.

Sulphur dioxide enters the reactor (6) through a compressor (16).

Since the reaction mass is heated when the reagents are fed, to prevent overheating of the reaction mass, simultaneously with feeding of the initial reagents, the reactor contents are cooled with water to maintain the reactor temperature not exceeding 70 °C. Cooling is provided by an immersion heat exchanger or a cooled jacket (7).

When feeding of stoichiometric amounts of ammonia and sulphur dioxide is complete, an additional amount of ammonia is introduced from the absorber (14) to increase the system pressure to 2-3 atm while heating the reaction mass to a temperature in the range from 90 to 120 °C due to feeding of excess ammonia. In this case, to maintain the temperature in the reactor (6) in the range of 90-120 °C, feeding of cooling water to the jacket (7) of the reactor (6) is stopped and feeding of steam to the jacket (7) of the reactor (6) from an autonomous steam generator is started (not shown in the figures).

Additional ammonia (excess dissolved ammonia) should be fed into the reactor to prevent decomposition of the resulting ammonium thiosulphate, since uncontrolled decomposition of the resulting ammonium thiosulphate can lead to an explosion of the reaction mixture. In a continuous process, it is advisable to use liquid ammonia, since the evaporation heat thereof can be spent on cooling the reaction mass.

The contents are mixed while sampling to monitor the completeness of the reaction of the ammonium thiosulphate synthesis.

The evaporator (17) is used to separate excess ammonia from the finished product, which is fed into the reactor to ensure the completeness of the reaction and prevent the decomposition of ammonium thiosulphate.

A decanter centrifuge (15) is used to separate excess unreacted sulphur from the finished product, which is returned to the hydrocyclone (3) to ensure continuity of the process of producing ammonium thiosulphate along with fresh sulphur.

The use of the evaporator (17) and the decanter centrifuge (15) in the process of producing ammonium thiosulphate allows increasing the rate of production of ammonium thiosulphate, reducing the total reaction time for producing ammonium thiosulphate, and increasing the yield and purity of the resulting product.

The finished solution is filtered from unreacted sulphur, which is recycled to step (a) of the process for producing ammonium thiosulphate.

### DETAILED DESCRIPTION OF DRAWINGS

FIG. 1 shows a process flow diagram for producing ammonium thiosulphate solution, comprising:
1—crystallizer
2—tank for suspension of elemental sulphur
3—hydrocyclone
4—ball mill
5—nozzle
6—reactor for the synthesis of ammonium thiosulphate
7—heat exchanger or jacket of reactor (6)
8—contact crystallizer feeding line
9—stirrer of tank (2)
10—submersible heat exchanger of tank (2)
11—pump of tank (2)
12—stirrer of reactor (6)
13—container with the finished product for sampling
14—ammonia absorber
15—decanter centrifuge
16—compressor
17—evaporator
18, 19, 20—pumps

FIG. 2 shows a unit for producing an aqueous suspension of elemental sulphur, comprising:
1—crystallizer
2—tank for suspension of elemental sulphur
3—hydrocyclone
4—ball mill
5—nozzle

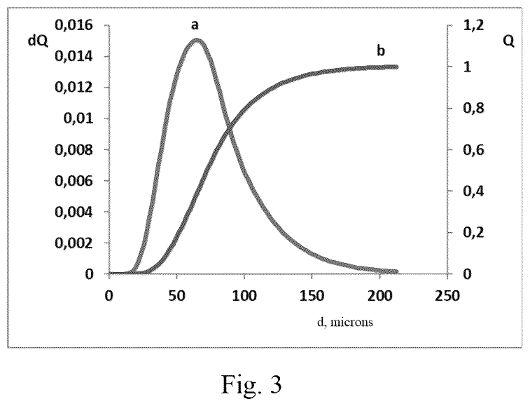

FIG. 3 shows the size distribution curves of sulphur particles produced by dispersing sulphur, where:
d is the effective particle size;
dQ (curve a) is a probability distribution that determines the probability of finding a particle of a given size in a given set.
Q (curve b) is the proportion of particles with a size equal to or less than a given one at a given point.

FIG. 3 shows the curves illustrating that the particle distribution is close to normal.

The use of finely dispersed elemental sulphur allows carrying out the ammonium thiosulphate synthesis reaction in one step without the need for additional equipment and reagents, which reduces the reaction time and increases the process productivity.

The essence of the present disclosure is disclosed in more detail in examples.

### Example 1

Water (500 ml) is loaded into the reactor (6) for the synthesis of ammonium thiosulphate through the hatch to provide a liquid medium in the reactor and the stirrer is turned on.

Further, the same hatch is used to load the reactor (6) with a 2:1 to 1:2 aqueous suspension of elemental sulphur:previously produced in the unit for producing the aqueous suspension of elemental sulphur.

To carry out the experiment according to example 1, a suspension of elemental sulphur with a particle size of 100-500 microns is used.

After loading the entire amount of the aqueous suspension of elemental sulphur into the reactor (6), the remaining amount of water is added as required for the experiment.

When loading water and aqueous suspension of elemental sulphur into the reactor (6) is complete, cooling water is fed to the jacket (7) of the reactor, the reactor (6) is sealed and purged with nitrogen to remove residual air that has entered the reactor through the open hatch and the purge gases are discharged into the neutralization system (not shown in the figures).

When the reaction medium temperature in the reactor (6) reaches 12-18 °C, ammonia and sulphur dioxide are fed. The ammonia feeding rate does not exceed 25-50 g/min. The sulphur dioxide feeding rate does not exceed 50-100 g/min. While feeding the reagents, the change in temperature and pressure in the reactor (6) is monitored. The maximum permissible temperature in the reactor (6) is 80 °C, the maximum permissible pressure in the reactor (6) is 2.8 kgf/cm².

When said amounts of reagents are fed into the reactor, the fed ammonia does not exceed 10% of the stoichiometric amount, feeding of cooling water to the jacket (7) of the reactor (6) is stopped and feeding of steam to the jacket (7) of the reactor (6) from an autonomous steam generator is started (not shown in the figures) to maintain the temperature in the reactor (6) in the range of 90-120 °C. The steam flow is set so that the temperature of the reaction mass in the reactor (6) is constant throughout the entire reaction time. The ammonium thiosulphate solution is periodically sampled from the sampling container to analyze the mixture for the content of ammonium thiosulphate and ammonium sulphite.

After the specified reaction time has elapsed, the steam feeding is stopped and feeding of cold water to the jacket (7) of the reactor (6) is started. After cooling the reaction mass in the reactor to a temperature not exceeding 40 °C, the water flow to the jacket (7) of the reactor (6) is stopped along with the mixer (12), the liquid reaction product is discharged into the sampling container (13), and the finished solution is filtered to separate ammonium thiosulphate from unreacted sulphur and analyze the finished filtrate and sediment. Gaseous products from the reactor are purged using nitrogen from the inert gas purge system into the neutralization system.

Table 1 shows the amounts of ingredients and reaction time to produce ammonium thiosulphate according to example 1.

TABLE 1

| | | | | Reaction |
|---|---|---|---|---|
| Ammonia, g | Sulphur dioxide, g | Sulphur, g | Water, ml | time, min |
| 700 | 1300 | 1000 | 2000 | 30 |

As a result of the reaction an ammonium thiosulphate solution was produced, where the ammonium thiosulphate content was 57 wt. %, and the ammonium sulphite content was 0.98 wt. %. In this case, the degree of conversion of sulphur dioxide into ammonium thiosulphate was 96%.

### Example 2

Ammonium thiosulphate was produced similarly to the process shown in example 1.

Moreover, in example 2, to obtain ammonium thiosulphate, a suspension of sulphur was used, in which the size of sulphur particles does not exceed 90 microns.

Table 2 shows the amounts of ingredients and reaction time to produce ammonium thiosulphate according to example 2.

TABLE 2

| | | | | Reaction |
|---|---|---|---|---|
| Ammonia, g | Sulphur dioxide, g | Sulphur, g | Water, ml | time, min |
| 700 | 1300 | 1000 | 2000 | 15 |

As a result of the reaction an ammonium thiosulphate solution was produced, where ammonium thiosulphate content was 61 wt. %, and the ammonium sulphite content was 0.95 wt. %. %. In this case, the degree of conversion of sulphur dioxide into ammonium thiosulphate was 98%.

As follows from the obtained results, the use of an aqueous suspension of sulphur with a particle size of less than 100 microns, preferably less than 90 microns, in the process of producing ammonium thiosulphate allows reducing the total reaction time for producing ammonium thiosulphate and leads to a higher yield and purity of the resulting product.

1. A process for producing ammonium thiosulphate by reacting ammonia, sulphur dioxide, and elemental sulphur in a reactor, comprising:
providing the reactor, the reactor being equipped with a mixing device and a heating and cooling system;
comminuting elemental sulphur and feeding the comminuted elemental sulphur into the reactor with water;
feeding stoichiometric amounts of ammonia and sulphur dioxide into the reactor while keeping contents of the reactor at a temperature of no more than 70 °C;
introducing an additional amount of ammonia while keeping the contents of the reactor at a temperature in the range of 90-120 °C; and
filtering a resulting solution of ammonium thiosulphate,
wherein a particle size of the elemental sulphur is less than 100 microns, and a minimum particle size of the elemental sulphur is 2 microns.

2. The process according to claim 1, wherein the elemental sulphur is fed into the reactor as an aqueous suspension.

3. The process according to claim 2, wherein the aqueous suspension of the elemental sulphur contains at least 75 wt. % sulphur particles having a size of less than 90 microns.

4. The process according to claim 2, wherein the aqueous suspension of the elemental sulphur is produced by dispersing a molten sulphur by spraying it through a pneumatic nozzle into water.

5. The process according to claim 4, wherein the particle size of the elemental sulphur is regulated by a rate of feeding the molten sulphur to the nozzle and by a rate of feeding-air and is controlled using a hydrocyclone.

6. The process according to claim 1, wherein the additional amount of ammonia fed into the reactor does not exceed 10% of the stoichiometric amount.

7. The process according to claim 1, wherein a temperature in the reactor is maintained using water or steam by a heat exchanger or a jacket.

8. The process according to claim 1, wherein a rate of feeding the ammonia does not exceed 25-50 g/min, and a rate of feeding the sulphur dioxide does not exceed 50-100 g/min.
